(19) United States
(12) Patent Application Publication
(10) Pub. No.: US 2018/0083274 A1
(43) Pub. Date: Mar. 22, 2018

(54) Secondary rechargeable battery

(71) Applicant: Iowa State University Research Foundation, Inc., Ames, IA (US)

(72) Inventor: Steve W. Martin, Ames, IA (US)

(73) Assignee: Iowa State University Research Foundation, Inc.

(21) Appl. No.: 15/732,089

(22) Filed: Sep. 14, 2017

Related U.S. Application Data
(60) Provisional application No. 62/495,504, filed on Sep. 16, 2016.

(51) Int. Cl. H01M 4/38; H01M 2/14; H01M 10/0568

(52) U.S. Cl. CPC H01M 4/381; H01M 10/0568; H01M 2/14

(57) ABSTRACT

The present invention provides a secondary battery. The battery includes an anode made of an alkali metal or alkaline earth metal, or an alloy or solid solution thereof, a cathode made of copper metal or alloy or a catholyte that comprises an aqueous solution of a soluble salt of the metallic cathode material to provide reducible cations of the metallic cathode material in the aqueous solution. An ion conducting separator functions to separate the anode and cathode. The battery can be operated over a wide temperature range from ambient temperature to about 150° C. The anode material can be pre-installed or can be produced in-situ on the anode side of the battery.

### RELATED APPLICATION

This application claims benefit and priority of provisional application Ser. No. 62/495,504 filed Sep. 16, 2016, the entire disclosure of which is incorporated herein by reference.

### CONTRACTUAL ORIGIN OF THE INVENTION

This invention was made with government support under Grant DE-AC04-94AL85000 awarded by the Department of Energy. The Government has certain rights in the invention.

### BACKGROUND OF THE INVENTION

Tremendous demands for the applications of portable devices, electric vehicles and stationary grid energy storage, the lack of conventional energy sources and environmental sustainability are requiring batteries, especially Li-ion secondary battery (e.g. rechargeable battery) to be developed quickly. However, conventional Li-ion batteries use organic electrolytes and then only can be operated at near ambient temperature (usually 0< to >60° C.), so the Li metal anode material is always in the solid state and this causes the problem of dendrite formation, and this can lead to fires and even explosions of the Li-ion batteries. Also, lithium metal is expensive due to the limited resources to bring up the cost.

Because sodium has a high energy density comparable with that of lithium and is non-toxic, abundant, and can be found as very low cost sodium salts, sodium secondary batteries have been considerably studied and developed. The conventional Na secondary, rechargeable, batteries, such as Na—S battery and Na—NiCl₂ battery (also called “Zebra Battery”) are typical molten metal/salts batteries which are operated at in the high temperature range of 300° C. to 350° C. At such high temperatures, the Na anode material and the non-aqueous electrolytes (sodium salts) are all in the molten states, and then the risk of forming sodium metal dendrites, which lead to explosion to fires, can be removed. However, the high operating temperature causes special safety issues, requires thermal management systems, leads to the degradation of battery performance due to corrosion, and limits the options of the candidate materials.

Accordingly, a secondary battery which possesses excellent voltage characteristic and energy density that can be operated at significantly lower temperatures is needed.

### SUMMARY OF THE INVENTION

The present invention provides a secondary (rechargeable) battery to this end which employs an anode (where oxidation occurs) comprising an anode material selected from at least one of an alkali metal and an alkaline earth metal and a cathode (where reduction occurs) comprising at least one of a metallic cathode material and a catholyte that comprises an aqueous solution of a soluble salt of the metallic cathode material to provide reducible cations of the metallic cathode material in the aqueous solution. The anode and cathode are separated by an ion-conductive solid separator that is conductive to cations of the anode material. The battery can be operated at a middle to low temperature range (for example, ambient temperature to about 150° C.) where the anode can be in a liquid, mushy (solid/liquid), or solid state.

In an illustrative embodiment of the invention, the anode comprises Li, Na, K, or alloys or solid solutions of two or more Li, Na and K. The separator is conductive to cations of at least one of these. The cathode can comprise a copper cathode material and/or an aqueous catholyte comprising a water soluble salt of Cu that provides reducible Cu cations in the aqueous solution. A water soluble salt of the anode material, such as a salt of Li, Na and/or K, can be present in the catholyte to provide cations of Li, Na and/or K in the aqueous solution.

The anode material can be pre-installed or produced in-situ inside the anode chamber of the battery wherein cations of the anode material are reduced at the anode during the initial charge cycle of the battery. In the in-situ production of the anode material, the initial battery material can be copper on the cathode side and the aqueous catholyte containing alkali metal-ion(s) in the aqueous solution. Such in-situ anode production considerably decreases the difficulties in manufacturing the batteries and significantly increases the overall safety of assembling the batteries.

Batteries pursuant to the present invention are advantageous in that they possess very low cost and use abundant sources of battery materials. The batteries possess high voltages and energy densities and can be used as portable power sources and/or as energy storage batteries for the renewable harvesting of energy such as the wind- and solar-based electric energy.

These and other advantages of the present invention will become more apparent from the following description taken with the following drawings.

### BRIEF DESCRIPTION OF DRAWINGS

FIG. 1 is a perspective view of an assembled secondary battery pursuant to an embodiment of the invention.

FIG. 2 is an exploded perspective view of the battery of FIG. 1 showing internal components.

FIG. 3 illustrates a current/voltage experiment at 105° C. showing a charge cycle and discharge cycle of a battery pursuant to an embodiment of the invention.

FIG. 4 illustrates a capacity versus voltage graph showing very low polarization for each charge-discharge cycle at 105° C.

FIG. 5 illustrates a cycle number versus capacity and shows coulombic efficiencies of 100% over 100 cycles at 105° C. Partial charge and discharge cycles are 100% efficient.

FIG. 6 illustrates voltage efficiency (cycle number versus voltage) over 100 cycles. The energy conversion efficiency (voltage efficiency×coulombic efficiency) is 96%-98% because the coulombic efficiency can be maintained at 100%.

FIG. 7 illustrates capacity versus voltage at different charge rates at 105° C. Even at 2 C rate, the battery shows good charge-discharge curves and capacity.

FIG. 8 illustrates that the battery retains stable plateau voltages at lower charge rates at 105° C. A modest voltage fade is observed at high charge rates.

### DETAILED DESCRIPTION OF THE INVENTION

The present invention provides a secondary (rechargeable) battery that is implemented for operation in a range of temperatures from ambient temperature to about 150° C. depending upon the anode material used. A preferred battery operating temperature is in the range from 50 to 110° C. for purposes of illustration and not limitation. The battery operating temperature can be below the melting point of the anode material where the anode material is in the solid state, or preferably at or above the melting point of the anode material where the anode is present in the liquid state or mushy (liquid plus solid) state.

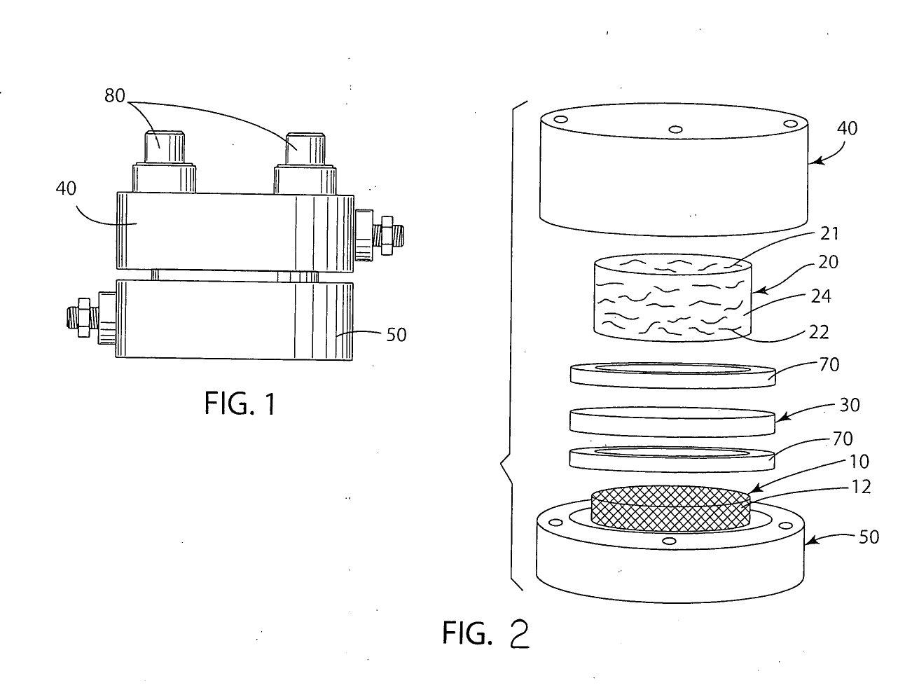

FIGS. 1 and 2 illustrate a secondary battery pursuant to an illustrative embodiment of the present invention wherein the battery comprises anode 10, cathode 20 comprising cathode material 22 and a catholyte 24, and ion-conductive solid separator 30 between the anode and the cathode. A cathode end plate and current collector encasing 40 and an anode end plate and current collector encasing 50 are connected by fasteners 80 extending through the respective encasing holes shown. Seal rings 70 are positioned as shown to seal the battery contents against fluid leakage. The encasings 40, 50 can be made of an electrically non-conductive material or electrically conductive material when they are insulated one from the other.

The anode 10 comprises an anode material 12 selected from at least one of an alkali metal and an alkaline earth metal. The alkali metal is selected from the group consisting of Li, Na, and K and alloys and solid solutions of two or more of Li, Na, and K. The alkaline earth metal is selected from the group consisting of Mg, Ca, and Ba and alloys and solid solutions of two or more of Mg, Ca, and Ba.

For purposes of illustration and not limitation, the anode 10 preferably comprises an Na (sodium) or K (potassium), or Na—K alloy or solid solution, wherein the alloy or solid solution can be NaₓK₁₋ₓ, where x is in the range of 0 to 1. With the change of the ratio of Na and K, the melting point of the anode material is changed such that a different operating temperature is used to retain the anode 10 in liquid state. For example, the melting point of pure sodium is 95 degrees Celsius and is altered by inclusion of K in alloy or solid solution form. Use of the liquid anode 10 is advantageous to reduce the risk of formation of the metal dendrites.

For purposes of further illustration and not limitation, in FIG. 2, the anode 10 can comprise pure Na metal deposited on ITO (indium tin oxide)-coated stainless steel mesh to which liquid or molten Na wets.

The oxidation part of the reversible redox reaction occurs at the anode 10 during the discharge cycle of the battery.

The battery also includes a cathode 20 where the reduction part of the reversible redox reaction occurs during the discharge cycle of the battery. To this end, the cathode 20 can comprise of a metallic cathode material 22 and/or a catholyte 24 that comprises an aqueous solution of a soluble salt of the metallic cathode material to provide reducible cations of the metallic cathode material in the aqueous solution.

For purposes of illustration and not limitation, the cathode material 22 can comprise copper metal or alloy, or other materials such as Fe, Ni, Co, Mn, Cr, V, or Zn. The cathode material can be copper metal (i.e., at least 98% copper in weight) or a copper metal alloy comprising a minimum of 5 weight % copper and a maximum of 95 weight % copper (e.g. brass—CuZn). The cathode material can be in any form including, but not limited to, copper metal or alloy wool, mesh, and powder.

In this illustrative embodiment, the catholyte 24 can comprise a water soluble salt of Cu when the cathode material comprises Cu to provide reducible Cu⁺² cations in the aqueous solution for reduction at the cathode side of the battery during the discharge cycle. The catholyte 24 also may include a water soluble salt of the anode material, such as a salt of Li, Na and/or K, to provide cations of Li, Na and/or K in the aqueous solution for in-situ generation of the anode material during the charge cycle of the battery as explained below.

For purposes of further illustration but not limitation, the water soluble alkali metal salts can include, but are not limited to, potassium perchlorate, potassium chloride, potassium nitrate, potassium hexafluorophosphate, potassium phosphate, potassium sulfate, sodium perchlorate, sodium chloride, sodium nitrate, sodium hexafluorophosphate, sodium phosphate, sodium sulfate, and the like. The water soluble copper salts can include, but are not limited to, copper perchlorate, copper chloride, copper nitrate, copper hexafluorophosphate, copper phosphate, copper sulfate, and the like.

For purposes of illustration and not limitation, in FIG. 2, the cathode 20 comprises aqueous catholyte-infused Cu metal wool with carbon felt where the Cu metal wool and the carbon felt are assembled by typically placing them in contact with one another. In a typical construction, the graphite felt 22 is placed adjacent to the solid electrolyte 30 and the Cu metal wool 24 is placed behind the graphite felt in the cathode chamber of the battery cell.

For purposes of illustration and not limitation, an exemplary reversible redox reaction that occurs when using the above-described Na anode material and Cu cathode material with 8.0M NaNO₃ and 1.0M Cu(NO₃)₂ aqueous catholyte is shown as equation (1) in the EXAMPLE below.

Equation (2) shows the initial charge cycle reaction of the battery to deposit Na in-situ on the ITO-coated stainless steel mesh.

Equation (3) shows the discharge cycle reaction where the Na anode material is oxidized to Na⁺ cations that pass through the ion conductive separator to the cathode side of the battery and where Cu⁺² cations are reduced to Cu⁰ at the cathode (e.g. at the Cu metal wool) and/or in the catholyte 24 itself.

The anode 10 and the cathode 20 are separated by an ion conductive solid separator 30 that is conductive to cations of the anode material. For purposes of illustration and not limitation, the separator 30 can comprise β″-Al₂O₃ or β″-Al₂O₃-containing compounds; e.g., β″-Al₂O₃/YSZ (yttria stabilized zirconia). In the β″-Al₂O₃-containing compounds, the content of β″-Al₂O₃ is a minimum of 10% by weight or 30% by volume. Also, the separator 30 can comprise other materials that can act as solid state ion conductors of the anode material; e.g., NaSICON [sodium (Na) Super Ion CONductor], which usually refers to a family of solids with the chemical formula Na_{1+x+4y}SiₓP₃₋ₓO₁₂ with x being equal to or greater than 1 and equal to or less than 3 and y being equal to or greater than 0 and equal to or less than 1.

Although FIGS. 1 and 2 illustrate certain battery shapes, sizes, and cross-sections, these features of the assembled battery can be determined according to its intended field of use of the battery. The assembled secondary battery 100 can have any cross sectional shape, such as a circle, a long circle, a rectangle, a rectangle with rounded corners, and the like. Also, the 3D shape of the assembled battery may include, but is not limited to, a planar shape, a coin shape, a cylindrical shape, and angular shape.

In making a battery pursuant to the invention, the anode material 12 can be pre-installed or produced in-situ inside the anode chamber of the assembled battery wherein cations of the anode material are reduced in-situ at the anode during initial charging of the battery and deposit on the ITO-coated stainless steel mesh (e.g. see equation 2 of the EXAMPLE below). In the in-situ production of the anode material, the initial battery material can be copper on the cathode side and the aqueous catholyte containing alkali metal-ion(s) in the aqueous solution. Such in-situ anode production considerably decreases the difficulties in manufacturing the batteries and significantly increases the safety of assembling the batteries.

The following EXAMPLE is offered to further illustrate but not limit a secondary battery pursuant to the present invention.

### Example

This EXAMPLE describes a Na—Cu secondary battery operable at 105° C. according to an illustrative embodiment of the present invention where the cathode material is Cu metal and the catholyte is an aqueous solution of 8.0M NaNO₃ and 1.0M Cu(NO₃)₂ constructed as described above (i.e. cathode comprises aqueous catholyte-infused Cu wool together with carbon felt).

A NaSICON separator conductive to Na⁺ ions was provided. The high catholyte salt loading totaling 9M dramatically reduces water vapor pressure and improves the Na⁺ ion conductivity of the aqueous catholyte solution.

A Na anode was formed in-situ on porous ITO-coated stainless mesh described above in the anode chamber when the battery is assembled in the discharged condition; i.e. with no Na anode material initially present. The Na anode material is deposited in accordance with the reaction of equation (2) below.

Reversible redox reaction: 2NaNO₃+Cu [symbol] 2Na+Cu(NO₃)₂ (1)

wherein

2NaNO₃+Cu→2Na+Cu(NO₃)₂ is the initial charge cycle reaction (2)

2Na+Cu(NO₃)₂→2NaNO₃+Cu is the discharge cycle reaction (3)

The NaSICON separator is available from Ceramatec Inc. of Salt Lake City, Utah. The ionic conductivity of the NaSICON separator was responsible for a measured resistance, reaction impedance and diffusion impedance, of the battery at 105° C. before cycles and after cycles.

The dimensions and other key parameters of the battery were:

Cathode—98% Cu metal wool and about 10 milligrams

Anode—Porous stainless steel mesh approximately 0.5 mm square mesh cut to a circle of approximately 25 mm in diameter.

Separator—NaSICON from Ceramatec 1 mm in thickness and 25 mm in diameter

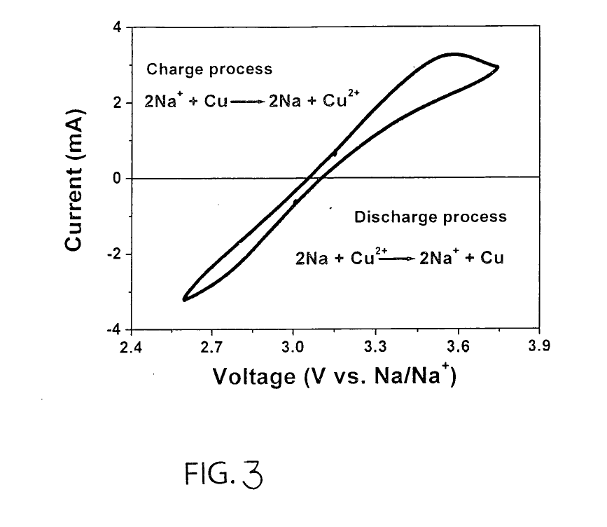

FIG. 3 illustrates a current/voltage test at 105° C. of the battery showing a measured charge cycle and discharge cycle. Initial charge was 0.3 mA for 5 hours=⅕ mAhr. Cu is the limiting reactant at 7 mAhr. Initial discharge was 0.3 mA for 4 hours=1.2 mAhr. Note that the test temperature of 105° C. is above the melting point of Na metal (97.72° C.).

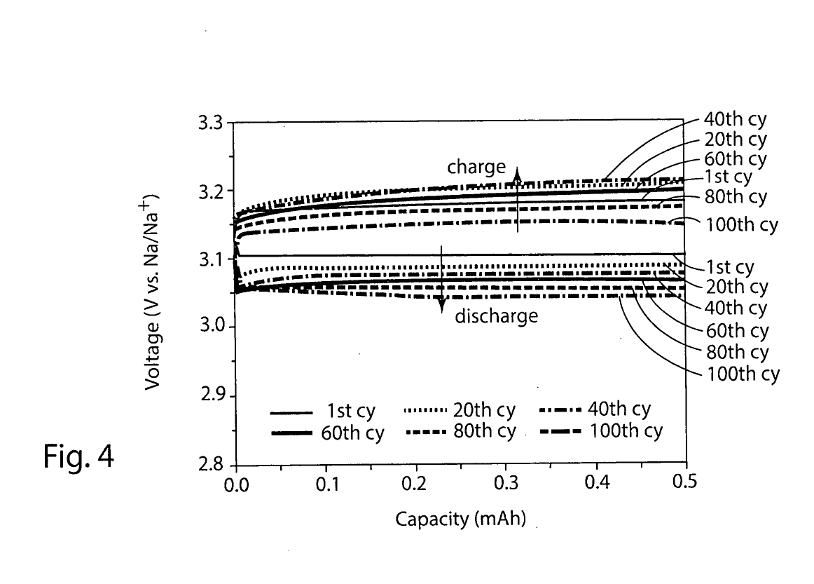

The reversible potential for the assembled Na—Cu secondary battery was 3.10 V. E⁰ values Na→Na⁺ 2.71 V (SHE); Cu⁺²+2e⁺→Cu⁰ 0.34 V (SHE)=3.05 V. The battery exhibited very close on-set potentials for the reduction and oxidation reactions, demonstrating the low polarization and high reversibility of the battery. For example, FIG. 4 illustrates a capacity versus voltage graph showing very low polarization for each charge-discharge cycle at 105° C. Excellent cycle-ability in excess of 100 cycles is observed. Initial testing was to about 10% of total capacity.

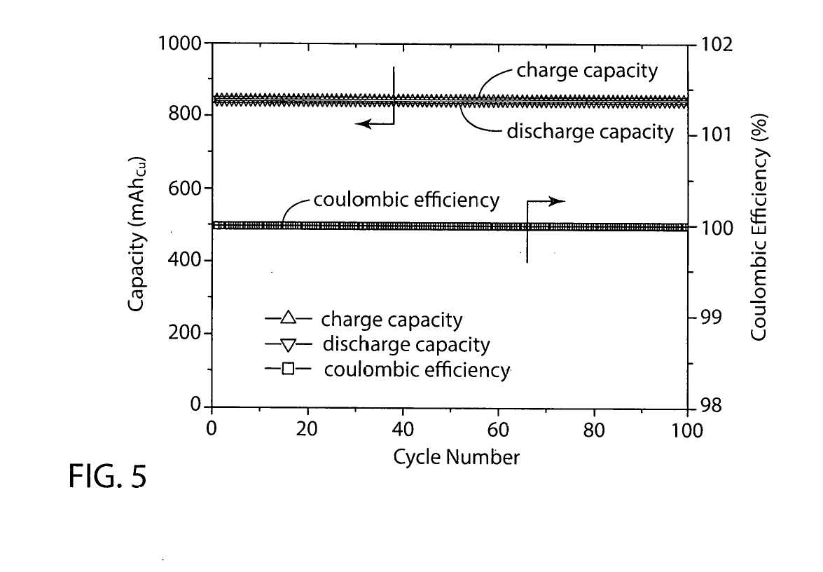

FIG. 5 illustrates a cycle number versus capacity and shows coulombic efficiencies of 100% over 100 cycles at 105° C. Partial charge and discharge cycles were 100% efficient.

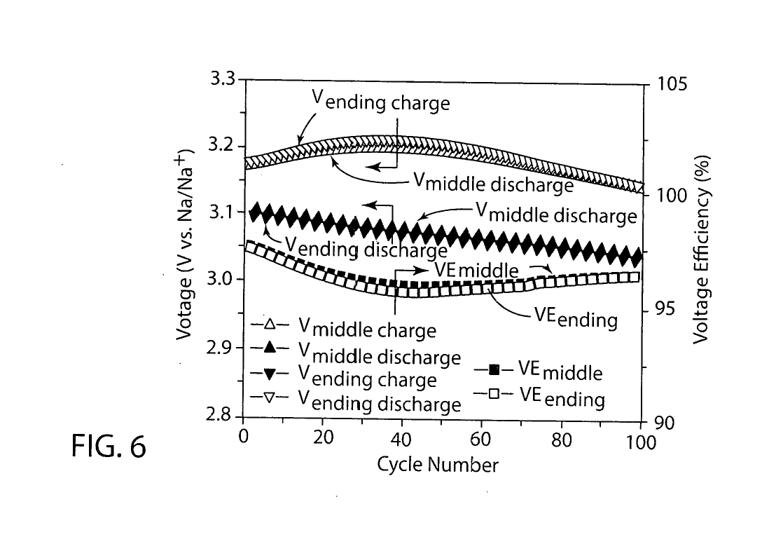

FIG. 6 illustrates voltage efficiency (cycle number versus voltage) over 100 cycles. The energy conversion efficiency (voltage efficiency×coulombic efficiency) was 96%-98% because the coulombic efficiency can be maintained at 100%.

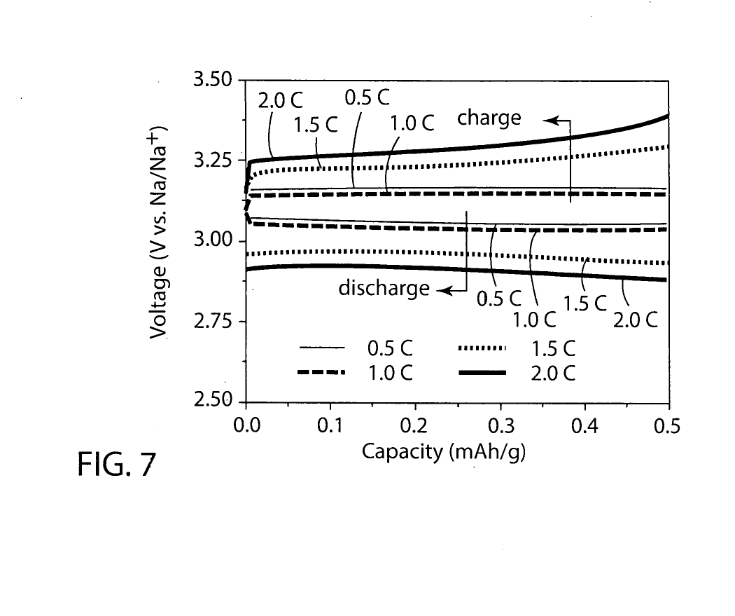

FIG. 7 illustrates capacity versus voltage at different charge rates at 105° C. Even at 2 C rate, the battery showed good charge-discharge curves and capacity.

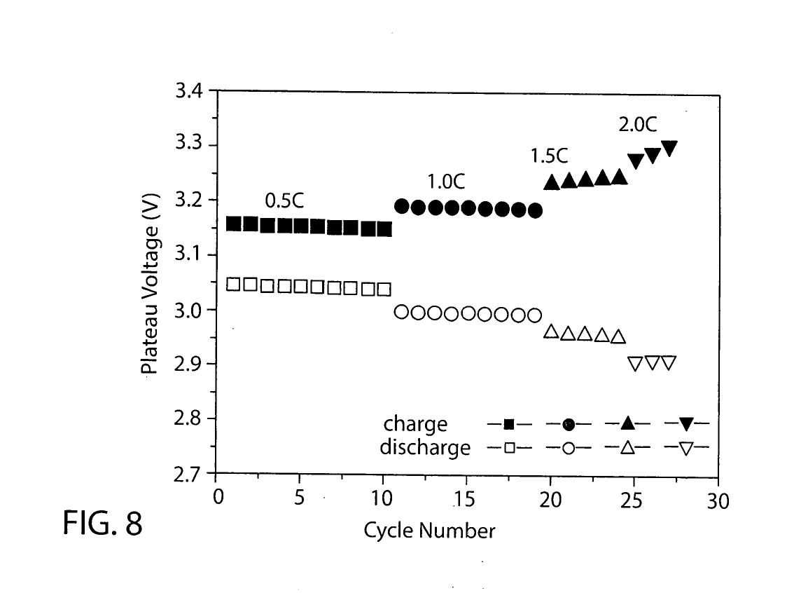

FIG. 8 illustrates that the battery retained stable plateau voltages at lower charge rates at 105° C. A modest voltage fade was observed at high charge rates.

Batteries pursuant to the present invention are advantageous in that they possess very low cost and use abundant sources of battery materials. The batteries possess high voltages and energy densities and can be used as portable power sources and/or as energy storage batteries for the renewable harvesting of energy such as the wind- and solar-based electric energy.

The embodiments disclosed in this specification and drawings are only illustrative examples to help to understand the invention while is not limited thereto. It is apparent to those in the art that various modifications based on the technological scope of the invention in addition to the embodiments disclose herein can be made within the scope of the appended claims.

We claim:

1. A secondary battery, comprising:
an anode where oxidation occurs, said anode comprising an anode material selected from the group consisting of an alkali metal and an alkaline earth metal, the anode being operable in a liquid, mushy, or solid state,
a cathode where reduction occurs, said cathode comprising at least one of a metallic cathode material and a catholyte that comprises an aqueous solution of a soluble salt of the metallic cathode material to provide reducible cations of the metallic cathode material in the aqueous solution, and
an ion conductive solid separator that is disposed between the anode and cathode, said separator being conductive to cations of the anode material.

2. The battery of claim 1 wherein the anode comprises at least one of Li, Na, and K.

3. The battery of claim 2 wherein the separator is conductive to cations of at least one of Li, Na, and K.

4. The battery of claim 1 wherein the metallic cathode material comprises Cu.

5. The battery of claim 1 wherein the catholyte comprises a water soluble salt of Cu.

6. The battery of claim 5 wherein the salt of Cu comprises Cu(NO₃)₂.

7. The battery of claim 1 wherein the catholyte also includes a water soluble salt of the anode material.

8. The battery of claim 7 wherein the soluble salt of the anode material comprises a salt of Li, Na and/or K.

9. The battery of claim 8 wherein the salt of Li, Na and/or K comprises LiNO₃, NaNO₃, or KNO₃.
